(19) United States
(12) Patent Application Publication
(10) Pub. No.: US 2024/0391847 A1
(43) Pub. Date: Nov. 28, 2024

(54) COATED GRANULAR FERTILIZERS WITH IMPROVED QUALITY METRICS

(71) Applicant: The Mosaic Company, Tampa, FL (US)

(72) Inventors: Kimberly Rinas, Regina (CA); Michael McLaughlin, Montacute (AU); Jozefien Degryse, Parkside (AU); Roslyn Baird, Aberfoyle Park (AU); Shervin Kabiri, Payneham South (AU); Addison Richards, Regina (CA); Jesse Nelson, Tampa, FL (US)

(21) Appl. No.: 18/674,312

(22) Filed: May 24, 2024

Related U.S. Application Data
(60) Provisional application No. 63/504,120, filed on May 24, 2023.

(51) Int. Cl. C05G 5/30; C05G 3/20; C05G 3/70

(52) U.S. Cl. CPC C05G 5/38; C05G 3/20; C05G 3/70

(57) ABSTRACT

An oil-based coating for fertilizer granules impregnated with an alpha olefin wax additive and related methods of applying the oil-based coating. The alpha olefin wax additive increases the viscosity of the oil-based coating and provides a substantial improvement to moisture resistance, thereby increasing the duration for which the coating is capable of controlling or inhibiting the formation of dust particulates from the fertilizer granules.

### RELATED APPLICATION(S)

The present application claims the benefit of U.S. Provisional Application Ser. No. 63/504,120, filed May 24, 2023, which is incorporated by reference in its entirety.

### FIELD OF THE DISCLOSURE

The present disclosure is directed to a dust control coating agent for reducing the dust generated in the production and transport of granulated fertilizer. Specifically, the present disclosure is directed to an oil-based coating with a wax additive, such as alpha olefin wax, or other additive dissolved in the oil-based coating that improves the longevity and moisture resistance of the oil-based coating for the purpose of controlling and reducing dust generation, moisture ingress, caking, and attrition.

### BACKGROUND OF THE DISCLOSURE

Many agricultural fertilizers are granulated and dried after formulation to provide the fertilizer in a stable and easily handled form. An inherent drawback of the conventional granulation and drying process is that a significant portion of the fertilizer is broken down into dust. The fertilizer can also be further broken-down during packaging, transport, and storage. Fertilizer with increased dusting is significantly more difficult to handle and distribute on the fields to be treated, as the dust is prone to becoming airborne such that its application is difficult to control. Accordingly, the fertilizer granules are often coated with an anti-dust coating that reduces or entraps the dust created during the granulation or transport.

The anti-dust coating often comprises petroleum or other oil-based liquids that are applied, such as by spraying, to the fertilizer granules to adhere any dust particulates formed, during granulation or transport, for example, to the larger fertilizer granules. The oil-based coating also encapsulates the dust particulates to prevent or inhibit the dust particulates from becoming airborne.

While oil-based coatings are effective at controlling the dust particulates, the inherent drawback of the oil-based coatings is that the coatings have a limited effective shelf-life and can have diminishing effectiveness as the coating ages. In particular, the coating itself can become dried with age and contribute to, rather than control, the dust problems. This can result in a significantly shortened shelf life of the fertilizer. Alternatively, prolonged storage or transport of the coated fertilizer can present a greater safety risk as the storage or transport time may have exceeded the effective life of the coating resulting in unsafe fertilizer products. As such, there is a need for prolonging and improving the effectiveness of oil-based dust control agents.

These and other advantages and features will become more apparent from the following description taken in conjunction with the drawings.

### SUMMARY OF THE DISCLOSURE

Embodiments of the present disclosure are generally directed to an oil-based coating for fertilizer granules, the coating being impregnated with an alpha olefin wax and related method of applying the oil-based coating. The alpha olefin wax is incorporated for increasing the viscosity of the oil-based coating, thereby increasing the duration for which the coating is capable of controlling or inhibiting the formation of dust particulates from the fertilizer granules.

The alpha olefin wax is added in low concentrations to improve the overall viscosity of the oil-based coating while retaining sufficient fluidity to allow the oil-based coating to be applied to the fertilizer granules via a coating application system such as a spray system, curtain coating system, or other such application methods known to those of skill in the art. The alpha olefin wax acts to strengthen the coating and increasing the effective life of the coating. Furthermore, the coating should be sufficiently degradable once applied to soil such that the fertilizer nutrients are readily released to the soil.

In embodiments, the coating comprises from about 50 to about 99 weight percent oil component and from about 1 to about 50 weight percent alpha olefin wax, more particularly from about 70 to about 90 weight percent oil component and from about 10 to about 30 weight percent alpha olefin wax, and even more particularly, but not limited to, 80 weight percent oil component and 20 weight percent alpha olefin wax. In embodiments, the coating comprises a ratio of about 1:1 to about 99:1 oil to alpha olefin wax, more particularly, a ratio of 2.33:1 to 9:1, and even more particularly 4:1.

In embodiments, the coating makes up from about 0.01 to about 5 weight percent of the entire fertilizer granule, more particularly from about 0.1 to about 1 weight percent, and more particularly 0.5 weight percent. In embodiments, the coating can have a thickness of from about 0.1 to about 10 μm. This thin coating ensures adequate dust control, without inhibiting release of the fertilizer's nutrients to the soil, once applied. Furthermore, other quality metrics are improved including, but not limited to, control of moisture ingress, attrition, and caking, for example.

In an embodiment, the method of forming a coated fertilizer granule comprises forming a quantity of fertilizer composition in a pre-neutralizer or reactor that is subsequently granulated within a rotating granulation drum to create a plurality of fertilizer granules. The method can also comprise combining an oil-based coating liquid heated to a temperature sufficient to melt or dissolve the alpha olefin wax within the liquid, such as, for example, a temperature in a range from about 150° F. to about 250° F., with a quantity of alpha olefin wax to form an oil-based coating solution for coating the formed fertilizer granules. The method can further comprise spraying, coating, or otherwise applying the oil-based coating solution onto the formed fertilizer granules to form a quantity of coated fertilizer granules.

The above summary of the various representative embodiments of the disclosure is not intended to describe each illustrated embodiment or every implementation of the disclosure. Rather, the embodiments are chosen and described so that others skilled in the art can appreciate and understand the principles and practices of the disclosure. The figures and the detailed description that follow more particularly exemplify these embodiments.

### BRIEF DESCRIPTION OF THE DRAWINGS

Subject matter hereof may be more completely understood in consideration of the following detailed description of various embodiments in connection with the accompanying figures, in which:

FIG. 1 illustrates a coated fertilizer granule, according to embodiments.

FIG. 2 illustrates a flow diagram of a method of making fertilizer granules having improved dust control, according to embodiments.

While the disclosure is amenable to various modifications and alternative forms, specifics thereof have been shown by way of example in the drawings and will be described in detail. It should be understood, however, that the intention is not to limit the disclosure to the particular embodiments described. On the contrary, the intention is to cover all modifications, equivalents, and alternatives falling within the spirit and scope of the disclosure as defined by the appended claims.

### DETAILED DESCRIPTION

Reference now will be made in detail to embodiments of the disclosure, one or more examples of which are illustrated in the drawings. Each example is provided by way of explanation in the disclosure and is not limited thereto. In fact, it will be apparent to those skilled in the art that various modifications and variations can be made in the present disclosure without departing from the scope of the disclosure. For instance, features illustrated or described as part of one embodiment can be used with another embodiment to yield a still further embodiment. Thus, it is intended that the present disclosure covers such modifications and variations as come within the scope of the appended claims and their equivalents. As used herein, the term “or” is generally intended to be inclusive (i.e., “A or B” is intended to mean “A or B or both”). The terms “first,” “second,” and “third” may be used interchangeably to distinguish one component from another and are not intended to signify location or importance of the individual components.

The terms “substantially,” “close,” “approximately,” “near,” and “about” generally refer to being within +/−10% of a target value. Unless otherwise specified the use of the ordinal adjectives “first,” “second,” and “third,” etc., to describe a common object, merely indicate that different instances of like objects are being referred to and are not intended to imply that the objects so described must be in a given sequence, either temporally, spatially, in ranking, or in any other manner.

It is to be understood that the terms so used are interchangeable under appropriate circumstances such that the embodiments of the disclosure described herein are, for example, capable of operation in other orientations than those illustrated or otherwise described herein.

The terms “left,” “right,” “front,” “back,” “top,” “bottom,” “over,” “under,” and the like in the description and in the claims, if any, are used for descriptive purposes and not necessarily for describing permanent relative positions.

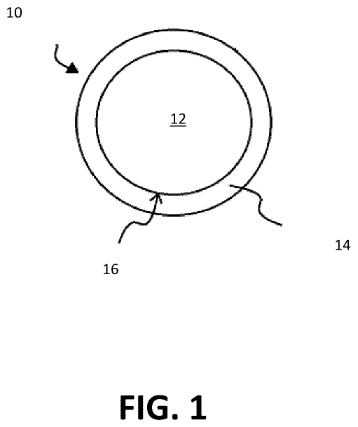

Referring to FIG. 1, a fertilizer granule 10 having a dust control coating agent includes a base fertilizer granule 12, with or without secondary nutrients and/or micronutrients, and a dust control coating agent 14 comprising a combination of oil and wax, such as an alpha olefin wax, in which there is a double bond between the first and second carbon atoms (alpha position) in each carbon chain, as described in more detail below. The dust control coating agent 14 can form either a continuous or non-continuous coating over an outer surface 16 of the granule 12 (and optionally over other coating(s), if present). Additional coatings or particles (not shown) such as primary, secondary, and/or micronutrients may optionally be applied to the dust control coating (not shown). In embodiments, the coating agent makes up from about 0.01 to about 5.0 weight percent of the entire fertilizer granule, more particularly from about 0.1 to about 1 weight percent, and more particularly 0.5 weight percent. This thin coating agent ensures adequate dust control, without significantly inhibiting release of the fertilizer's nutrients to the soil, once applied.

The oil component can comprise any of a variety of coating oils, such as, for example, various oils derived from agriculture (such as vegetable oils) or byproducts of hydrocarbon crude purification (such as tail oils or distillation bottoms). In embodiments, the coating oil can comprises a commercially available proprietary coating oil. In embodiments, the wax additive can be an alpha olefin wax, such as linear alpha olefins (LAO) or normal alpha olefins (NAO). In embodiments, LAOs and NAOs are olefins or alkenes with a chemical formula CₓH₂ₓ, distinguished from other mono-olefins with a similar molecular formula by linearity of the hydrocarbon chain and the position of the double bond at the primary or alpha position. In an example, the LAOs and NAOs can comprise branched alpha olefins, linear alpha olefins, or combinations thereof having a range of C₂₄-C₅₄. LAOs, for example, may include 1-butene, 1-hexene, 1-octene, 1-decene, 1-dodecene, 1-tetradecene, 1-hexadecene, 1-octadecene and higher olefin blends of C₂₀-C₂₄, C₂₄-C₃₀, and C₂₀-C₃₀ ranges, and more generally C₂₄-C₅₄. NAOs possess highly accessible, terminal, double-bonds. NAOs, for example, may include one or more commercially available alpha olefin waxes available from Industrial Raw Materials LLC sold under the tradenames IRM-Alpha2021, IRM-Alpha 2024 (melting point of 96 F), IRM-Alpha2440 (melting point of 146 F), IRM-Alpha2628 (melting point of 126 F), IRM-Alpha3050 (melting point of 164 F), and IRM-Alpha3056 (melting point of 155 F-congealing). In one example, the alpha olefin wax additive may increase the viscosity of the oil-based coating at ambient temperatures, thereby increasing the duration for which the coating is capable of controlling or inhibiting the formation of dust particulates from the fertilizer granules, while decreasing the viscosity at elevated temperatures. In embodiments, depending on the manufacturer, many alpha olefin waxes with a carbon fraction above C₂₀ will be solid at room temperature. Thus, in embodiments, a substantial improvement to moisture resistance of the fertilizer granules may be realized when the alpha olefin wax is blended into the oil component.

As described above, the wax additive is added in low concentrations to improve the overall viscosity of the oil-based coating while retaining sufficient fluidity to allow the oil-based coating liquid to be applied to the fertilizer granules via a spray system. In embodiments, the coating comprises from about 50 to about 99 weight percent oil component and from about 1 to about 50 weight percent alpha olefin wax additive, more particularly from about 70 to about 90 weight percent oil component and from about 10 to about 30 weight percent alpha olefin wax additive, and even more particularly 80 weight percent oil component and 20 weight percent alpha olefin wax additive. In embodiments, the coating comprises a ratio of about 1:1 to about 99:1 oil to alpha olefin wax additives, more particularly, a ratio of 2.33:1 to 9:1, and even more particularly 4:1.

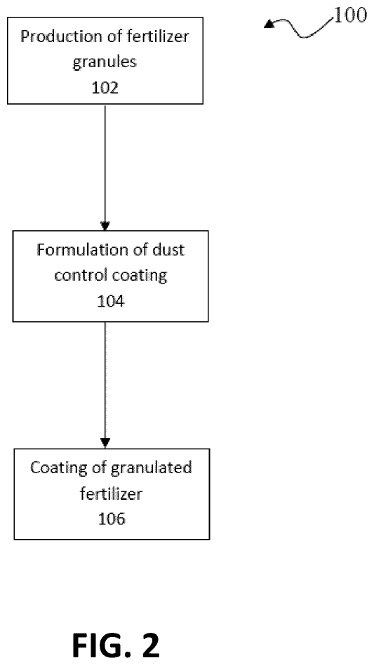

FIG. 2 shows a method 100 of producing a coated fertilizer granule, according to an embodiment of the present disclosure, generally comprises a fertilizer production stage 102, a coating preparation stage 104, and a coating application stage 106. Additional reference is made to FIG. 2, which depicts a coated fertilizer granule, according to an embodiment of the present disclosure.

As shown in FIG. 2, in the fertilizer production stage 102, a quantity of fertilizer granules are produced, as described in, for example, U.S. Pat. No. 7,497,891, entitled “Method for producing a fertilizer with micronutrients,” incorporated herein by reference in its entirety, and U.S. Pat. No. 6,544,313, entitled “Sulfur-containing fertilizer composition and method for preparing same,” incorporated herein by reference in its entirety, U.S. Pat. No. 10,611,701, entitled “Swellable fertilizer granules containing elemental sulfur with increased oxidation rates,” U.S. Pat. No. 9,266,784, entitled “Compacted muriate of potash fertilizers containing micronutrients and methods of making same,” incorporated herein by reference in its entirety, and U.S. Pat. No. 10,717,682, entitled “Fertilizers containing slow and fast release sources of boron, incorporated herein by reference in its entirety. The base fertilizer can include, but is not limited to, phosphates, nitrates, urea, potash, pure crystal products, or combinations thereof, providing one or more primary nutrients including carbon, hydrogen, oxygen, nitrogen, phosphorous, and potash. In a particular embodiment, the fertilizer is a phosphate fertilizer such as, for example, monoammonium phosphate (MAP), diammonium phosphate (DAP), single superphosphate, triple superphosphate, or combinations thereof.

Depending on the needs of the target plant, the fertilizer can also include one or more secondary nutrients, such as, for example, calcium, sulfur, and magnesium, one or more micronutrients such as, for example, zinc, manganese, iron, copper, molybdenum, boron, chlorine, cobalt, and sodium, or any combination thereof.

Individual fertilizer granules may be produced by granulation and/or compaction depending on the method of production, or may be pure crystal products or nitrogen based products. For example, granulation includes formulation of the fertilizer slurry, and then granulation in a rolling bed granulator, with or without a sparger (e.g., ammonia sparger), and with or without a spray applicator for addition of one or more secondary nutrients and/or micronutrients, as known to one of ordinary skill in the art. The granules are dried, such as in a drier drum, and are then screened for size. Granules that are too large or too small relative to a predetermined target size are separated from the others. Oversized particles are ground or crushed to the target size or to an undersized particle to be combined with other undersized particles. The undersized particles are recycled back to the granulator.

In coating preparation stage 104, which can be performed either at a location of the fertilizer production stage 102, or at another location by the same or different party, the dust control coating agent is prepared by combining the oil component and the alpha olefin wax additive by melting and metering the alpha olefin wax additive into the oil component. The oil component is heated prior to or during the addition of the melted alpha olefin wax additive. In certain embodiments, the oil component is heated to a temperature in a range of from about 100° F. to about 300° F., and more particularly from about 150° F. to about 250° F. In embodiments, an alpha olefin wax is melted and metered into a coating oil such that the dust control coating agent comprises 80 weight percent coating oil and 20 weight percent alpha olefin wax. The coating is then mixed until homogeneous.

In coating application stage 106, the heated dust control coating agent is sprayed, coated, or otherwise applied onto the individual fertilizer granules, such as, for example, in a rolling bed to ensure complete or nearly complete coating of the granules. Coating application stage 106 can be done in line with fertilizer production stage 102, such as, for example, upon cooling of the fertilizer granules after granulation, or can be done in a separate process as fertilizer production stage 102.

In embodiments, the coating agent is applied at a rate (e.g., 0.1-1.0 gal of coating per ton of fertilizer granules) such that the coating agent makes up from about 0.01 to about 5.0 weight percent of the entire fertilizer granule, more particularly from about 0.1 to about 1 weight percent, and more particularly 0.5 weight percent. The fertilizer granules are cooled until the coating is solidified. The coating on the exterior surface of the fertilizer granule is thin such that the size of the fertilizer granules is not substantially affected. In embodiments, the coating ranges in thickness of from about 0.1 to 10 about μm.

In embodiments, the coated fertilizer granules can be of various sizes and shapes. Typically, the coated fertilizer granules may be substantially spherical, having an average diameter of from about 0.5 to about 7.5, about 0.5 to about 3, about 1 to about 2, mm, or any average diameter between about 0.5 and about 7.5 mm. However, the coated fertilizer granules can be of other shapes, such as irregular, pocked, oblong, rectangular or platelet shaped.

Various embodiments of systems, devices, and methods have been described herein. These embodiments are given only by way of example and are not intended to limit the scope of the claimed inventions. On the contrary, the intention is to cover all modifications, equivalents, and alternatives falling within the spirit and scope of the disclosure as defined by the appended claims. It should be appreciated that the various features of the embodiments that have been described may be combined in various ways to produce numerous additional embodiments. Moreover, while various materials, dimensions, shapes, configurations, and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112 (f) are not to be invoked unless the specific terms “means for” or “step for” are recited in a claim.

1. A fertilizer product comprising:
a plurality of fertilizer granules, each granule having a dust control coating thereon, the coating including an oil component and an alpha olefin wax blended within the oil component.

2. The fertilizer product of claim 1, wherein the oil component is present in an amount of from about 50 to about 99 weight percent and the alpha olefin wax component is present in an amount of from about 1 to about 50 weight percent.

3. The fertilizer product of claim 2, wherein the oil component is present in an amount of from about 70 to about 90 weight percent and the alpha olefin wax component is present in an amount of from about 10 to about 30 weight percent.

4. The fertilizer product of claim 3, wherein the oil component is present in an amount of about 80 weight percent and the alpha olefin wax component is present in an amount of about 20 weight percent.

5. The fertilizer product of claim 1, wherein the dust control coating is from about 0.01 to about 5 weight percent of the entire fertilizer granule.

6. The fertilizer product of claim 5, wherein the dust control coating is from about 0.1 to about 1 weight percent.

7. The fertilizer product of claim 1, wherein the coating has a thickness of from about 0.1 to about 10 μm.

8. The fertilizer product of claim 1, wherein alpha olefin wax includes alpha olefins having a range of C₂₄-C₅₄.

9. The fertilizer product of claim 1, wherein alpha olefin wax comprises 1-butene, 1-hexene, 1-octene, 1-decene, 1-dodecene, 1-tetradecene, 1-hexadecene, 1-octadecene, olefin blends in a range of C₂₀-C₂₄, olefin blends in a range of C₂₄-C₃₀, olefin blends in a range of C₂₀-C₃₀, olefin blends in a range of C₂₄-C₅₄, or combinations thereof.

10. The fertilizer product of claim 1, wherein the oil component comprises an oil derived from agriculture, a byproduct of hydrocarbon crude purification, or combinations thereof.

11. A dust control coating comprising an alpha olefin wax blended into an oil component.

12. The coating of claim 11, wherein the oil component is present in an amount of from about 50 to about 99 weight percent and the alpha olefin wax component is present in an amount of from about 1 to about 50 weight percent.

13. The coating of claim 12, wherein the oil component is present in an amount of from about 70 to about 90 weight percent and the alpha olefin wax component is present in an amount of from about 10 to about 30 weight percent.

14. The coating of claim 13, wherein the oil component is present in an amount of about 80 weight percent and the alpha olefin wax component is present in an amount of about 20 weight percent.

15. The coating of claim 11, wherein alpha olefin wax comprises 1-butene, 1-hexene, 1-octene, 1-decene, 1-dodecene, 1-tetradecene, 1-hexadecene, 1-octadecene, olefin blends in a range of C₂₀-C₂₄, olefin blends in a range of C₂₄-C₃₀, olefin blends in a range of C₂₀-C₃₀, olefin blends in a range of C₂₄-C₅₄, or combinations thereof.

16. The coating of claim 11, wherein the oil component comprises an oil derived from agriculture, a byproduct of hydrocarbon crude purification, or combinations thereof.

17. A method of forming a coated fertilizer granule having a dust control coating thereon, the method comprising:
providing a plurality of fertilizer granules;
providing an alpha olefin wax;
providing a fluid oil component heated to a temperature at or above a melting temperature of the alpha olefin wax;
melting the alpha olefin wax within the fluid oil component to form the dust control coating; and
coating the plurality of fertilizer granules with the dust control coating.

18. The method of claim 17, wherein the temperature of the fluid oil component is in a range from about 150° F. to about 250° F.

19. The method of claim 17, wherein providing the alpha olefin wax comprises providing the alpha olefin wax to the oil component at a rate such that the oil component is present in an amount of from about 50 to about 99 weight percent and the alpha olefin wax component is present in an amount of from about 1 to about 50 weight percent.

20. The method of claim 17, wherein coating the plurality of fertilizer granules comprises spraying the coating onto the plurality of fertilizer granules within a drum;
rotating or moving the drum to distribute the coating; and
allowing the plurality of fertilizer granules to cool.
